(19) United States
(12) Patent Application Publication
(10) Pub. No.: US 2010/0054926 A1
(43) Pub. Date: Mar. 4, 2010

(54) SYSTEM AND METHOD FOR THERMAL MANAGEMENT OF A GAS TURBINE INLET

(75) Inventors: Hua Zhang, Greer, SC (US); David Wesley Ball, JR., Easley, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/201,491

(22) Filed: Aug. 29, 2008

(51) Int. Cl. F02C 7/141

(52) U.S. Cl. 415/178

(57) ABSTRACT

A thermal management system includes: a turbine assembly including an inlet housing, a compressor in fluid communication with the inlet housing, a power turbine in fluid communication with the compressor, and an exhaust assembly in fluid communication with the power turbine; and at least one heat pipe having a first portion disposed in thermal communication with the inlet housing and a second portion disposed in thermal communication with the exhaust assembly, the at least one heat pipe configured to transfer thermal energy from the exhaust assembly to at least one of input gas entering the inlet housing and at least one component of the inlet housing.

### BACKGROUND OF THE INVENTION

The subject matter disclosed herein relates to gas turbines and, more particularly, to methods and systems for managing turbine component temperature.

In freezing conditions, and especially where freezing conditions and precipitation exist, gas turbines and other turbomachinery are susceptible to damage. For example, ice build-up in and around an inlet portion of a gas turbine, such as on the filter housing and inlet guide vanes, can impede the proper operation of components of the turbine. In addition, pieces of ice could be ingested into the turbine and impact interior components, risking damage to components and possible failure.

Current techniques for removing or preventing ice build-up use steam or compressor discharge air to heat the inlet portion. For example, one technique includes transmitting steam from a heat recovery steam generator to coils that are placed in front of a filter housing in an inlet assembly. Another technique includes bleeding compressor discharge air into the inlet housing to warm the inlet air. Such techniques are very expensive and detrimental to overall turbine cycle efficiency. Accordingly, there is a need for improved systems and methods for managing thermal energy in a gas turbine, that provide for effective thermal management of the gas turbine inlet without compromising efficiency.

### BRIEF DESCRIPTION OF THE INVENTION

A thermal management system, constructed in accordance with exemplary embodiments of the invention includes: a turbine assembly including an inlet housing, a compressor in fluid communication with the inlet housing, a power turbine in fluid communication with the compressor, and an exhaust assembly in fluid communication with the power turbine; and at least one heat pipe having a first portion disposed in thermal communication with the inlet housing and a second portion disposed in thermal communication with the exhaust assembly, the at least one heat pipe configured to transfer thermal energy from the exhaust assembly to at least one of input gas entering the inlet housing and at least one component of the inlet housing.

Other exemplary embodiments of the invention include a method of thermal management of a turbomachine. The method includes: introducing an input gas into a turbine assembly through an inlet housing and through a compressor; combining the input gas with a fuel and igniting the fuel to produce an exhaust; transferring thermal energy from the exhaust to at least one heat pipe, the at least one heat pipe having a first portion disposed in thermal communication with the inlet housing and a second portion disposed in thermal communication with the exhaust; and transferring the thermal energy from the at least one heat pipe to at least one of input gas entering the inlet housing and at least one component of the inlet housing.

Additional features and advantages are realized through the techniques of exemplary embodiments of the invention. Other embodiments and aspects of the invention are described in detail herein and are considered a part of the claimed invention. For a better understanding of the invention with advantages and features thereof, refer to the description and to the drawings.

### BRIEF DESCRIPTION OF THE DRAWINGS

FIG. 1 is a side view of a gas turbine including a thermal management system in accordance with an exemplary embodiment of the invention;

FIG. 2 is another exemplary embodiment of a thermal management system; and

FIG. 3 is a flow chart providing an exemplary method for heating inlet air in a gas turbine.

### DETAILED DESCRIPTION OF THE INVENTION

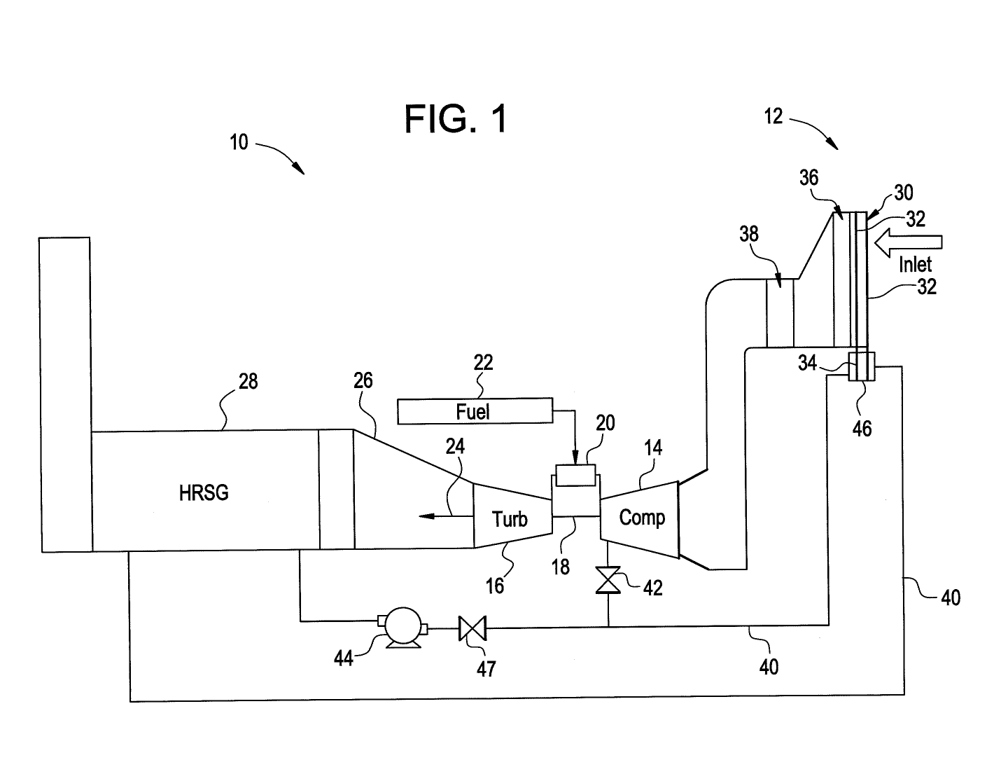

With reference to FIG. 1, a gas turbine assembly constructed in accordance with an exemplary embodiment of the invention is indicated generally at 10. The gas turbine assembly 10 includes an inlet housing 12, a compressor 14 and a power turbine 16 connected to the compressor 14 via a rotor 18. A combustion chamber 20 is in fluid communication with both the compressor 14 and the power turbine 16, and is further in communication with a fuel source 22. Fuel from the fuel source 22 and compressed air from the compressor 14 are mixed and ignited in the combustion chamber 20. Hot gas product 24 of the combustion flows to the power turbine 16 which extracts work from the hot gas 24, and thereafter flows to an exhaust duct 26. In one embodiment, the turbine assembly 10 includes a heat recovery steam generator (HRSG) 28 that recovers heat from the hot exhaust 24 and produces steam that is usable in, for example, a steam turbine in an electrical generation system.

In one embodiment, the turbine assembly includes one or more thermal conduits such as heat pipes 30. The heat pipe 30 forms a sealed enclosure, and includes a first portion 32 that is in thermal communication with a portion of the inlet housing 12 and second portion 34 that is in thermal communication with a source of thermal energy such as the compressor 14, the exhaust duct 26 and/or the HRSG 28. In one embodiment, the portion 32 of the heat pipe 30 is located inside the inlet housing 12 proximate to a filter 36, a silencer 38 and/or other inlet components such as inlet guide vanes. In one embodiment, a plurality of heat pipes 30 are included. The number, position and configuration of heat pipes 30 is not limited and may be disposed in any suitable configuration sutiable to expose input gases and or inlet components to thermal energy.

In one embodiment, the heat pipe 30 is a sealed pipe or tube including one or more fluids disposed therein. In use, when one portion such as the second portion 34 heats up, the fluids therein evaporate and the resulting vapor flows to the first portion 32 which is generally of a lower temperature. The vapor condenses on the wall of the pipe 30 in the first portion 32, which releases heat and causes the surrounding inlet air to heat up. In another embodiment, the first portion 32 is disposed in contact with one or more of the inlet components. In one embodiment, convection takes thermal energy from the first portion 32 into the inlet housing 12 to increase the temperature of the surrounding inlet air and/or the inlet components.

In another embodiment, each heat pipe 30 is a solid state heat pipe (SSHP) in which thermal energy from the compressor 14, the exhaust duct 26 and/or the HRSG 28 is absorbed by a highly thermally conductive solid medium disposed in a vacuum cavity formed within the heat pipe 30 and/or disposed on an inside surface of the heat pipe 30. Thermal energy migrates via the solid medium from the high temperature second portion 34 to the low temperature first portion 32 where it heats the surrounding air.

In one example, the heat pipe 30 is a sealed vacuum tube having its interior surface coated with Qu-material. The Qu-material serves to conduct thermal energy from the second portion 34 to the first portion 32.

The heat pipe 30 is disposed in thermal communication with a fluid conduit such as a hot gas and/or steam pathway 40. In one embodiment, the hot gas and/or steam pathway 40 is any suitable fluid or gas conduit such as an insulated pipe. In one embodiment, the pathway 40 is connected in fluid communication to one or more compressor bleed valves 42 and the HRSG 28, so that hot gas and/or steam can be introduced to the pathway 40 and delivered to the heat pipe 30. Although the pathway is shown herein as connected to the HRSG 28, in other embodiments the pathway is connected to the compressor bleed valve 42, the HRSG 28, the exhaust duct 26 and/or other sources of heated gas or liquid.

The pathway 40 forms a loop connecting the thermal sources including the compressor bleed 42, the HRSG 28 and/or the exhaust duct 26 with the heat pipe 30. The loop is configured to transfer a flow of hot gas from the thermal sources to the heat pipe 30 and back to a location downstream of the exhaust duct 26. In this way, the hot gas and/or steam remains in the turbine system so that the thermal energy of the hot gas and/or steam can be more fully used to extract power therefrom. In one embodiment, a blower 44 or other pumping device is disposed in fluid communication with the pathway 40 to force gas and/or steam through the pathway and toward the heat pipe 30. Optional valves 47 are disposed in fluid communication with the pathway 40 to further control a fluid flow within the pathway 40.

In one embodiment, a thermal transfer structure 46 is disposed in fluid communication and/or thermal communication with the pathway 40 to transfer thermal energy between the pathway 40 and the heat pipe 30. The thermal transfer structure 46 is of any suitable form sufficient to conduct thermal energy between the pathway 40 and the heat pipe 30. In one embodiment, the structure 46 is a hollow chamber formed in fluid communication with the pathway 40. The second portion 34 of the heat pipe 30 is disposed in an interior of the structure 46 or is otherwise in contact with the structure 46 to receive thermal energy therefrom.

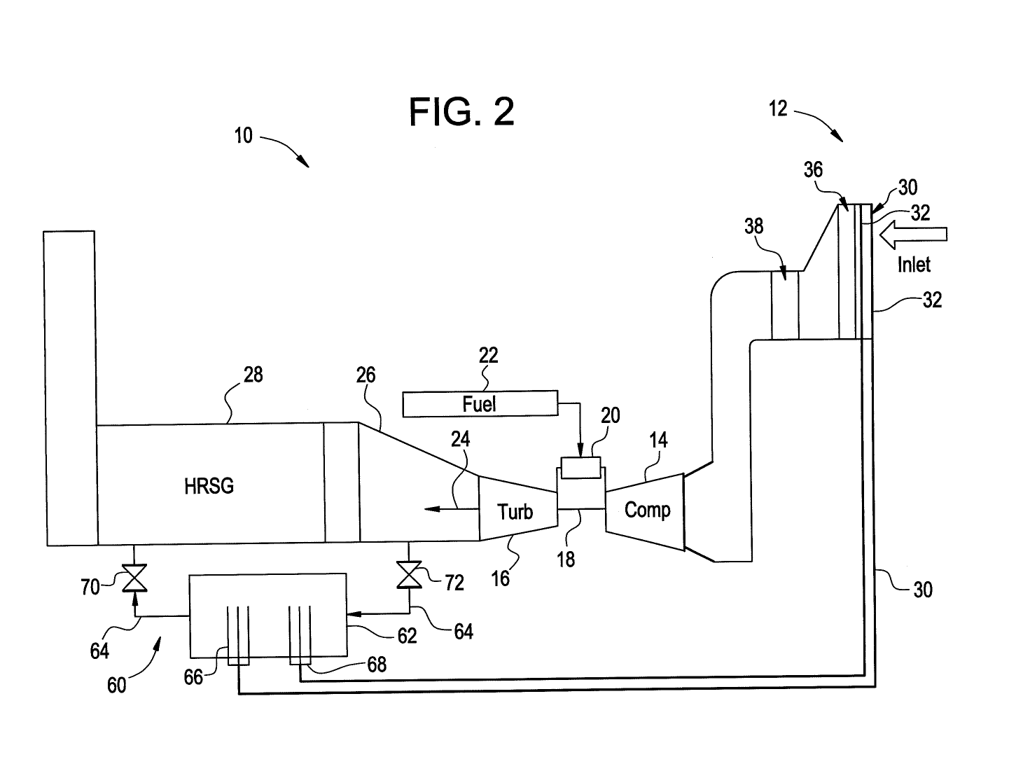

Referring to FIG. 2, in another embodiment, the heat pipe 30 is disposed in thermal communication with a sealed fluid conduit 60 that includes a hot gas pathway 62. In one embodiment, the hot gas pathway 62 is any suitable fluid or gas conduit configured as an enclosure such as a box or pipe. Secondary pipes or other pathways 64 are connected in fluid communication between the HRSG 28 and/or the exhaust duct 26, and the hot gas pathway 62, so that hot gas can be introduced to the pathway 62 to deliver thermal energy to the heat pipe 30. One or more heat pipe portions 66, for example one or more branch heat pipes, are thermally connected to the hot gas pathway 62. In one embodiment, the one or more branch heat pipes 66 extend into an interior of the hot gas pathway 62 to receive thermal energy from the hot gas. In one embodiment, the branch heat pipes are connected to heat pipe headers 68, which collect thermal energy from branch heat pipes 66 and transfer the thermal energy to the cold section 32 of the heat pipes 30 and into the inlet 12. One or more valves 70, 72 may be included in the fluid conduit 60 to control the amount of thermal energy transfered to the inlet 12.

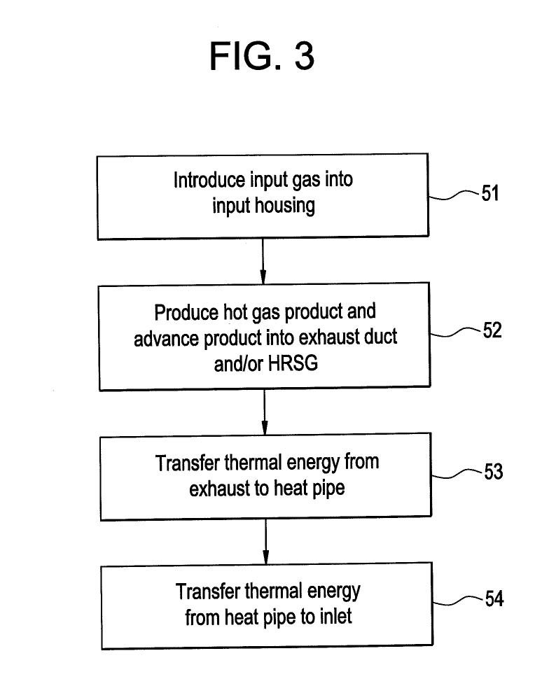

FIG. 3 illustrates an exemplary method 50 for thermal management of a gas turbine or other turbomachine. The method 50 includes one or more stages 51-54. In an exemplary embodiment, the method includes the execution of all of stages 51-54 in the order described. However, certain stages may be omitted, stages may be added, or the order of the stages changed.

In the first stage 51, an input gas such as ambient air is introduced through the inlet housing 12. The input gas flows to the compressor 14, where it is successively compressed.

In the second stage 52, the compressed input gas is combined with fuel and the mixture is ignited in the combustion chamber 20 to produce exhaust such as the hot gas product 24. The hot gas product 24 is advanced into the exhaust conduit 26 and/or the HRSG 28.

In the third stage 53, thermal energy is transferred from the exhaust and/or the HRSG 28 to at least one heat pipe 30. In one embodiment, the thermal energy is transferred from the exhaust to the second portion 34.

In one embodiment, the thermal energy is transferred from the exhaust and circulated through the fluid conduit 40 or the fluid conduit 60. In another embodiment, additional thermal energy is transferred directly from the compressor 14 to the fluid conduit 40 through, for example, the compressor bleed valve 42. In one embodiment, the compressor bleed valve is opened and used to provide thermal energy to the pathway 40 during start-up and shutdown of the turbine assembly 10, i.e., during acceleration to rated speed and deceleration from rated speed. During normal operation, thermal energy is provided to the pathway 40 from the HRSG 28 and/or the exhaust duct 26.

In the fourth stage 54, the thermal energy from the heat pipe 30 is transferred to input gas entering the inlet housing 12 and/or at least one component of the inlet housing 12. In one embodiment, thermal energy is transferred from the second portion 34 to the first portion 32 of the heat pipe 30 by evaporating liquid disposed in the second portion 34 and transferring a portion of the thermal energy to the first portion 32 via condensation. In another embodiment, the thermal energy is transferred from the heat pipe 30 by conducting the thermal energy from the second portion 34 to the first portion 32 through a thermally conductive solid.

Although the systems and methods described herein are provided in conjunction with gas turbines, any other suitable type of turbine, turbomachine or other device incorporating inlet and exhaust materials may be used. For example, the systems and methods described herein may be used with a steam turbine or a turbine including both gas and steam generation.

The system and method described herein provide numerous advantages over prior art systems. The system and method allows for increased efficiency of the turbine system while providing effective heating of the inlet or other components for de-icing and/or anti-icing. In combined cycle units, for example, the heat transfer system described herein can be incorporated with a HRSG system to minimize the impact on steam turbine efficiency. Other advantages include system simplicity, avoidance of the need to transfer steam, reduced noise, and avoidance of negative impact on compressor operation.

Prior art techniques such as techniques that utilize discharge of compressor air into the inlet are very expensive and costly to combined cycle efficiency. For example, when ambient temperature falls bellow 40 degrees F. and relative humidity is greater than 67%, 2.5% of compressor discharge air is needed for anti-icing, which causes gas turbine efficiency drop 2% to 4%. Using steam to heat inlet air is very expensive in equipment cost and reduces steam turbine power output. Accordingly, use of the system and method described herein can potentially save, for example, 1% to 2% of gas turbine efficiency when anti-icing is required and 2% to 3% when de-icing is required relative to other techniques.

The capabilities of the embodiments disclosed herein can be implemented in software, firmware, hardware or some combination thereof As one example, one or more aspects of the embodiments disclosed can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the disclosed embodiments can be provided.

In general, this written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of exemplary embodiments of the invention if they have structural elements that do not differ from the literal language of the claims, or if they include equivalent structural elements with insubstantial differences from the literal language of the claims.

1. A thermal management system comprising:
a turbine assembly including an inlet housing, a compressor in fluid communication with the inlet housing, a power turbine in fluid communication with the compressor, and an exhaust assembly in fluid communication with the power turbine; and
at least one heat pipe having a first portion disposed in thermal communication with the inlet housing and a second portion disposed in thermal communication with the exhaust assembly, the at least one heat pipe configured to transfer thermal energy from the exhaust assembly to at least one of input gas entering the inlet housing and at least one component of the inlet housing.

2. The system of claim 1, wherein the input gas is ambient air.

3. The system of claim 1, wherein the at least one heat pipe is a sealed enclosure including at least one of a liquid and a thermally conductive solid.

4. The system of claim 1, wherein the at least one heat pipe is a sealed enclosure including at least one liquid, and the at least one heat pipe is configured to evaporate the at least one liquid in the second portion in response to the thermal energy and transfer a portion of the thermal energy to the first portion via condensation.

5. The system of claim 1, wherein the at least one heat pipe is a solid state heat pipe including a thermally conductive solid disposed on an interior surface of the at least one heat pipe.

6. The system of claim 5, further comprising a sealed conduit in fluid communication with the exhaust assembly, the second portion of the at least one heat pipe being disposed in an interior of the sealed conduit and in thermal communication with the sealed conduit.

7. The system of claim 1, wherein the exhaust assembly includes a heat recovery steam generator (HRSG) in thermal communication with the second portion.

8. The system of claim 1, further comprising a fluid conduit having a first end and a second end that are connected in fluid communication with the exhaust assembly, the fluid conduit configured to form a loop in thermal communication with the second portion of the at least one heat pipe.

9. The system of claim 1, further comprising a compressor bleed valve in fluid communication with the compressor and in thermal communication with the at least one heat pipe.

10. The system of claim 9, further comprising a fluid conduit having a first end and a second end that are connected in fluid communication with the exhaust assembly, the fluid conduit configured to form a loop in thermal communication with the second portion of the at least one heat pipe, the loop configured to be connected in fluid communication with the compressor bleed valve.

11. A method of thermal management of a turbomachine, the method comprising:
introducing an input gas into a turbine assembly through an inlet housing and through a compressor;
combining the input gas with a fuel and igniting the fuel to produce an exhaust;
transferring thermal energy from the exhaust to at least one heat pipe, the at least one heat pipe having a first portion disposed in thermal communication with the inlet housing and a second portion disposed in thermal communication with the exhaust; and
transferring the thermal energy from the at least one heat pipe to at least one of input gas entering the inlet housing and at least one component of the inlet housing, thereby thermally managing the turbomachine.

12. The method of claim 11, wherein the at least one heat pipe is a sealed enclosure including at least one of a liquid and a thermally conductive solid.

13. The method of claim 12, wherein transferring the thermal energy from the at least one heat pipe includes evaporating the liquid in the second portion in response to the thermal energy and transferring a portion of the thermal energy to the first portion via condensation.

14. The method of claim 12, wherein transferring the thermal energy from the at least one heat pipe includes conducting the thermal energy from the second portion to the first portion through the thermally conductive solid.

15. The method of claim 11, wherein transferring thermal energy from the exhaust includes circulating the exhaust through a sealed conduit in fluid communication with the exhaust and transferring thermal energy from the sealed conduit to the second portion of the at least one heat pipe, and the second portion is disposed in an interior of the sealed conduit.

16. The method of claim 11, wherein the exhaust includes steam generated by a heat recovery steam generator (HRSG) in thermal communication with the second portion.

17. The method of claim 11, wherein transferring the thermal energy from the exhaust includes circulating the exhaust through a fluid conduit having a first end and a second end that are connected in fluid communication with the exhaust, the fluid conduit configured to form a loop in thermal communication with the second portion of the at least one heat pipe.

18. The method of claim 11, further comprising transferring additional thermal energy from the compressor to the at least one heat pipe.

19. The method of claim 18, wherein the additional thermal energy is transferred through a compressor bleed valve in fluid communication with the compressor and in thermal communication with the at least one heat pipe.

20. The method of claim 18, wherein transferring additional thermal energy includes circulating a portion of the inlet gas from the compressor to a fluid conduit having a first end and a second end that are connected in fluid communication with the exhaust, the fluid conduit configured to form a loop in thermal communication with the second portion of the at least one heat pipe.
